(19) United States
(12) Patent Application Publication
(10) Pub. No.: US 2005/0103456 A1
(43) Pub. Date: May 19, 2005

(54) Apparatus and method for embossing a multi-ply paper product

(75) Inventors: Ferdinand Hein, Mannheim (DE); Thomas Heilemann, Frankenthal (DE); Jan-Peter Brunback, Torslanda (SE)

Correspondence Address: YOUNG & THOMPSON, 745 SOUTH 23RD STREET, 2ND FLOOR, ARLINGTON, VA, 22202, US

(73) Assignee: SCA HYGIENE PRODUCTS GMBH, MANNHEIM (DE)

(21) Appl. No.: 10/940,722

(22) Filed: Sep. 15, 2004

Related U.S. Application Data
(60) Provisional application No. 60/513,569, filed on Oct. 24, 2003.

(51) Int. Cl. B31F 1/07

(52) U.S. Cl. 162/117; 162/132; 162/362; 156/209; 156/219; 425/385

(57) ABSTRACT

Apparatus for embossing a multi-ply paper product, includes at least one background embossing unit, for embossing at least one ply of the multi-ply paper product and at least one decoration embossing unit for embossing the at least one ply downstream of the background embossing unit, as seen in the direction of processing, the decoration embossing unit having a decoration embossing roll and a decoration backing roll. The decoration embossing roll of the decoration embossing unit has an engraving depth larger than 1.5 mm. By this arrangement, an increased bulk of the produced multi-ply paper product can be achieved, the decoration embossing having sharp edges, which in turn leads to an improved application of dye, if dyed glue is used for laminating the plies together. To strengthen this fact, it is preferable that the decoration backing roll has a hardness larger than 60 Shore (A).

### 1. FIELD OF THE INVENTION

The present invention relates to an apparatus and a method for embossing a multi-ply paper product to be used in the manufacture of such a product. At least one ply of the multi-ply paper product has a background embossing, so as to soften the paper product and bring a web structure to the surface of the paper product, and a decoration embossing so as to give a more aesthetical impression to the paper product. Thus, the present invention relates to an apparatus for embossing a multi-ply paper product, comprising at least one background embossing unit for embossing at least one ply of the multi-ply paper product and at least one decoration embossing unit for embossing the at least one ply downstream of the background embossing unit, as seen in the direction of processing. The paper product is generally formed from a continuous web and may be made from tissue paper or non-woven material.

A tissue paper is defined as a soft absorbent paper having a low basis weight. One generally selects a basis weight of 8 to 30 g/m², especially 10 to 25 g/m² per ply. The total basis weight of multiple-ply tissue products is preferably equal to a maximum of 65 g/m², more preferably to a maximum of 50 g/m². Its density is typically below 0.6 g/cm³, preferably below 0.30 g/cm³ and more preferably between 0.08 and 0.20 g/cm³.

The production of tissue is distinguished from paper production by the its extremely low basis weight and its much higher tensile energy absorption index (see DIN EN 12625-4 and DIN EN 12625-5). Paper and tissue paper also differ in general with regard to the modulus of elasticity that characterizes the stress-strain properties of these planar products as a material parameter.

A tissue's high tensile energy absorption index results from the outer or inner creping. The former is produced by compression of the paper web adhering to a dry cylinder as a result of the action of a crepe doctor or in the latter instance as a result of a difference in speed between two wires (“fabrics”). This causes the still moist, plastically deformable paper web to be internally broken up by compression and shearing, thereby rendering it more stretchable under load than an uncreped paper.

Moist tissue paper webs are usually dried by the so-called Yankee drying, the through air drying (TAD) or the impulse drying method.

The fibers contained in the tissue paper are mainly cellulosic fibres, such as pulp fibers from chemical pulp (e.g. Kraft sulfite and sulfate pulps), mechanical pulp (e.g. ground wood), thermo mechanical pulp, chemo-mechanical pulp and/or chemo-thermo mechanical pulp (CTMP). Pulps derived from both deciduous (hardwood) and coniferous (softwood) can be used. The fibers may also be or include recycled fibers, which may contain any or all of the above categories. The fibers can be treated with additives—such as fillers, softeners, such as quaternary ammonium compounds and binders, such as conventional dry-strength agents or wet-strength agents used to facilitate the original paper making or to adjust the properties thereof. The tissue paper may also contain other types of fibers, e.g. regenerated cellulosic fibres or synthetic fibers enhancing, for instance, strength, absorption, smoothness or softness of the paper.

Tissue paper may be converted to the final tissue product in many ways, for example, by embossing or laminating it into a multi-ply product, rolled or folded.

The term non-woven (ISO 9092, DIN EN 29092) is applied to a wide range of products which, in terms of their properties, are located between those of paper (cf. DIN 6730, May 1996) and cardboard (DIN 6730) on the one hand, and textiles on the other hand. As regards non-woven a large number of extremely varied production processes are used, such as the air-laid and spun-laced techniques as well as wet-laid techniques. The non-woven includes mats, non-woven fabrics and finished products made thereof. Non-wovens may also be called textile-like composite materials, which represent flexible porous fabrics that are not produced by the classic methods of weaving warp and weft or by looping. In fact, non-wovens are produced by intertwining, cohesive or adhesive bonding of fibres, or a combination thereof. The non-woven material can be formed of natural fibres, such as cellulose or cotton fibres, but can also consist of synthetic fibres, such as Polyethylene (PE), polypropylene (PP), polyurethane (PU), polyester, nylon or regenerated cellulose, or a mix of different fibres. The fibres may, for example, be present in the form of endless fibres of pre-fabricated fibres of a finite length, as synthetic fibres produced in situ, or in the form of staple fibres. The nonwovens according to the invention may thus consist of mixtures of synthetic and cellulose fibrous material, e.g. natural vegetable fibres (see ISO 9092, DIN EN 29092).

Hygiene or wiping products primarily include all kind of dry-creped tissue paper, wet-creped paper and cellulose or pulp wadding or all kinds of nonwovens, or combinations, laminates or mixtures thereof. Typical properties of these hygiene and wiping products include the ready ability to absorb tensile stress energy, their drapability, good textile-like flexibility, properties which are frequently referred to as bulk softness, a high surface softness, and a high specific volume with a perceptible thickness. As high a liquid absorbency as possible and, depending on the application, a suitable wet and dry strength as well as an appealable visual appearance of the outer product surface is desired. These properties, among others, allow these hygiene and wiping products to be used, for example, as cleaning wipes such as paper or non-woven wipes, windscreen cleaning wipes, industrial wipes, kitchen paper, or the like; as sanitary products such as for example toilet paper, paper or non-woven handkerchiefs, household towels, towels, and the like; as cosmetic wipes such as for example facials and as serviettes or napkins, just to mention some of the products that can be used. Furthermore, the hygiene and wiping products can be dry, moist, wet or pre-treated in any manner. In addition, the hygiene and wiping products may be folded, interleaved or individually placed, stacked or rolled, connected or not, in any suitable manner.

Due to the above description, the products can be used for personal and household use as well as commercial and industrial use. They are adapted to absorb fluids, for decorative purposes, for packaging or even just as supporting material, as is common for example in medical practices or in hospitals. In terms of their wide variety, hygiene and wiping products are now considered to be everyday products.

### 2. PRIOR ART

In the prior art, multi-ply tissue paper products are known having a decoration embossing and a micro embossing as background embossing. According to conventional manufacturing processes, first a micro embossing is applied to the tissue ply/plies and, in a second step, a decoration embossing is added to the top ply/plies. Subsequently, glue is applied on the protuberances, to laminate the top ply/plies and the bottom ply/plies together.

Such a tissue paper product is, for example, known from EP-A-0 797 705. The paper product comprises a background embossing pattern in the form of a micro embossing commonly having a density of between 30 dots/cm² and 80 dots/cm². However, in such prior art tissue paper products, the pre-micro embossing, i.e. the background embossing is conducted ahead of the decoration embossing, so that compression and loss of thickness of the background embossing results during the step of decoration embossing. In addition, the optical appearance of the tissue paper product is impaired.

FIG. 1 shows an example of an embossing part of a standard machine for producing multi-plied decoration embossed products. The embossing part consists, for example, of two embossing units (1,2), wherein the first embossing unit (1) consists of two background embossing sections (3) each having a rubber backing roll (5) and a steel embossing roll (4). These background embossing sections serve for the application of a micro background embossing to one or more plies of a multi-ply paper product. In the present case, a two-ply paper product is to be manufactured, each ply being embossed with a background pattern by the respective embossing unit. The rubber backing roll and the steel embossing roll form an embossing/backing roll combination (3). The steel embossing rolls (4) and the rubber rolls (5) are arranged in a way that an embossing nip of 10 to 30 mm (depending on the roll diameter; in the present case 180 mm) is formed between the rolls and the rubber roll is pressing with a force of approximately 12.000 N/m against the embossing roll. The rubber rolls conventionally have a hardness of approximately 50 Shore (A) and the embossing micro pattern (6) has a density of e.g. 40 dots/cm².

The pre-embossed top ply/plies (7) and the bottom ply/plies (8) are subsequently transferred to a decoration embossing unit (2) for embossing at least one ply downstream of the background embossing unit as seen in the direction of processing, i.e. from the left to the right in the drawing. The decoration embossing unit also comprises an embossing/backing roll combination (9). The embossing roll may be a steel embossing roll or a roll covered with hard rubber, e.g., an ebonite covered roll. The decoration embossing roll (10) has protuberances on its surface, which are design elements distributed on the roll. The standard engraving depth of the embossing roll (10) is commonly from 1.2 up to at most 1.5 mm. The decoration backing roll (11) with a hardness of about 50 Shore (A) presses on the surface of the decoration embossing roll to create a pressing area in which the top ply/plies (7) receives the embossment of the design protuberances.

After embossment of the decoration elements, an adhesive is applied onto the top of the protuberances which are embossed in the web material. Preferred adhesives are among others, carboxymethylcellulose(CMC), or special polymerisates, such as polyvinyl alcohols (PVOH), polyvinyl acetates (PVAc), copolymerisates of ethylene and vinyl acetate(EVA), copolymerisates of styrene and butadiene, polyurethanes having suitable cross-linking agents (for instance polyols or polyamines) or polymerisates on the basis of acrylic acid and/or methacrylic acid, and derivatives thereof, including alkylesters thereof such as n-butylacrylate or methylmethacrylate or cyano derivates thereof such as cyanoacrylate. The step of applying the adhesive is performed by an adhering station (13) consisting of an adhesive chamber, which applies adhesive on a steel or ceramic transferation roll (20) having a rough surface. This adhesive transferation roll (20) is in contact with an adhesive application roll (21), having a rubber surface. Adhesive will be applied to the tops of the raised portions (protuberances) while passing the adhering unit. A lamination between the top and the bottom ply/plies will be obtained when the webs are brought together and compressed in a marrying nip. Marrying the plies is performed by pressing a rubber-coated roll (12) with a rubber hardness for approximately 80 Shore (A) on the decoration embossing roll (10) (with approximately 5.600 N/m). Preferred adhesives are glues based on CMC, PVOH, EVA, PVAc, which are commonly used for tissue products. The adhesive may additionally be dyed. However, due to smooth edges of the decoration embossing the dye will drain away and smear. After lamination, the multi-ply web is transferred to the rewinding unit. By means of such an apparatus according to the prior art, a multi-ply paper product having a background embossing and a decoration embossing can be obtained.

However, as the decoration embossing is applied to the paper product already being micro-embossed or background-embossed, the background embossing is impaired in the step of decoration embossing by compression and, thus, results in a loss of thickness. In other words, the designs of the decoration embossing roll are pressed into the rubber of the decoration backing roll so that the paper product will be compressed in the clearances between the decoration elements, in which the rubber backing roll engages, and, hence, the paper product will be reduced in its thickness.

In order to create more bulk, an alternative, conventional apparatus may be used to apply a macro-embossing on a middle ply of the multi-ply paper product. However, this apparatus is only applicable for paper products having at least three plies. In FIG. 2, an apparatus for embossing a multi-ply paper product is shown in which, compared to the apparatus in FIG. 1, a middle ply (14) of the paper product is embossed in an additional middle embossing/backing roll combination (15) consisting of a rubber backing roll (16) and an embossing roll (17) with a macro pattern (18). By this configuration, products with a minimum of three plies can be manufactured which are increased in bulk compared to products obtained by the aforementioned apparatus. However, this approach is not applicable for two-ply products. In addition, the middle embossing/backing combination (15) requires an additional drive to cope with the different web elongations caused by the different embossing patterns. In addition, although more bulk than in the standard apparatus as described with respect to FIG. 1 can be created by means of the middle ply embossing, this bulk is again partly lost in the step of decoration embossing, as the web undergoes the aforementioned compression.

In alternative (compared to the above) process for manufacturing multi-ply tissue paper products having a decoration embossing and a micro embossing as background embossing, the micro pattern and the decoration pattern are combined on one embossing roll and the paper is concurrently embossed with both patterns.

### 3. SUMMARY OF THE INVENTION

Accordingly, it is the technical problem underlying the present invention to provide an apparatus and a method for embossing a multi-ply paper product comprising at least one background embossing unit for embossing at least one ply of the multi-ply paper product and at least one decoration embossing unit for embossing the at least one ply downstream of the background embossing unit, as seen in the direction of processing, in which the loss of bulk of the paper product in the decoration embossing unit can be reduced, which enables a larger flexibility in the election of the background pattern, enables an increase in the edge sharpness of the edges of the decoration embossing, which in turn leads to an improved application of dye in the sense of a sharp application, if a dyed glue is used to laminate the plies, and enables production of a multi-ply paper product having an improved optical appearance, thus solving the technical problems of the prior art.

In particular, the present invention provides an apparatus for embossing a multi-ply paper product, comprising at least one background embossing unit, for embossing at least one ply of the multi-ply paper product and at least one decoration embossing unit for embossing the at least one ply downstream of the background embossing unit, as seen in the direction of processing, wherein the decoration embossing unit having a decoration embossing roll and a decoration backing roll. The apparatus of the present invention is characterized in that the decoration embossing roll of the decoration embossing unit has an engraving depth larger than 1.5 mm. Preferably, the engraving depth is larger than 1.5 mm and less than or equal to 3.5 mm, more preferably in the range of between 1.7 mm and 2.3 mm, and, most preferred, 2.0 mm. By employing a decoration embossing roll having such an engraving depth, it can be ensured that, in step of decoration embossing, the pre-background embossing is not or only slightly compressed in the clearances between the decoration designs, such that the bulk of the paper product achieved in the background embossing unit can be maintained. Consequently, the decrease in bulk or thickness can be prevented. Further, the variety of embossing patterns that can be used for the background patterns is increased because the optical appearance and the mechanical properties thereby generated are not affected by the subsequent decoration embossing unit. Additionally, the edge sharpness is increased, thus improving the optical appearance of the paper product. In particular, if a dyed adhesive is used for laminating the plies together, the decoration embossing, which would be hardly distinguished from the background embossing in a white-on-white product, can be highlighted. Because of the sharp edges, the dye does not drain away into the background embossing, providing the decoration embossing with a sharp contour. In other words, the decoration embossing can be accurately dyed.

To amplify this advantageous effect, in a preferred embodiment of the present invention, the decoration backing roll has a hardness greater than 60 Shore (A), preferably greater than 60 Shore (A) and less than or equal to 95 Shore (A), more preferably in the range of between 75 and 85 Shore (A) and, most preferred, 80 Shore (A). By providing a backing roll with such hardness, the designs of the decoration embossing roll are not pressed into the decoration backing roll as deep as in conventional apparatuses. Consequently, the paper product in the clearances between the designs is not compressed as much as in the conventional apparatus, because the rubber backing roll in the present invention engages the clearances much less than in the conventional apparatus. In addition to the large engraving depth, this amplifies the afore-mentioned effect. But also if taken alone, i.e. with a standard decoration embossing roll having an engraving depth of between 1.2 mm and 1.5 mm, a decoration embossing roll having such hardness would solve the object underlying the present invention.

Preferably, the decoration backing roll is made of natural or synthetic rubber, for example, polybutadiene or copolymers of ethzylene and propylene, paper, cardboard polyamide, textile or the like.

Advantageously, the background embossing unit is adapted to apply a macro-embossing to the one ply of the paper product. A macro-embossing mainly serves to improve the thickness of a paper product. Thus, by using a macro-embossing as background embossing, the bulk of the paper product can be further increased. A macro-embossing has less than 25 knobs, preferably between 5 and 16 knobs per cm².

However, the background embossing unit may be also adapted to apply a standard micro-embossing to the one ply of the paper product. A micro-embossing is mainly used to improve handfeel and drapability of the paper product and has in general more than 25 knobs up to 200 knobs per cm².

Alternatively, the background embossing may also be a combination of a micro- and a macro-embossing.

Preferably, the micro-embossing pattern is substantially uniformally applied to the one ply of the paper product and comprises approximately 40 dots/cm². The micro-embossing may also be applied to some or all plies of the paper product.

Preferably, the apparatus is capable of producing a paper product having at least three plies, wherein the background embossing unit further comprises a middle embossing/backing roll combination for applying a macro-embossing to a middle-ply of the multi-ply paper product. By this feature, the bulk of the paper product can be even further increased.

Preferably, the apparatus further comprises a calender unit upstream and downstream of the embossing units, as seen in the direction of processing, which increases the softness or smoothness of the paper product and also increases its optical appearance.

Furthermore, the present invention provides a multi-ply paper product manufactured by means of an apparatus as described above.

In addition, the present invention provides a corresponding method for embossing a multi-ply paper product.

### 4. BRIEF DESCRIPTION OF THE DRAWINGS

In the following, preferred embodiments of the present invention will be described with reference to the accompanying drawings, in which same parts bear the same reference numerals.

FIG. 1 is a side view of a state of the art apparatus for embossing a multi-ply paper product.

FIG. 2 is a side view of an alternative apparatus according to the prior art, in which the middle ply of a three-ply product is embossed with a macro pattern.

FIG. 3 shows a preferred embodiment of the present invention.

FIG. 4 shows a micro background pattern.

FIG. 5 shows a macro-embossing pattern.

FIG. 6 shows a decoration embossing pattern.

### 5. DETAILED DESCRIPTION OF THE INVENTION

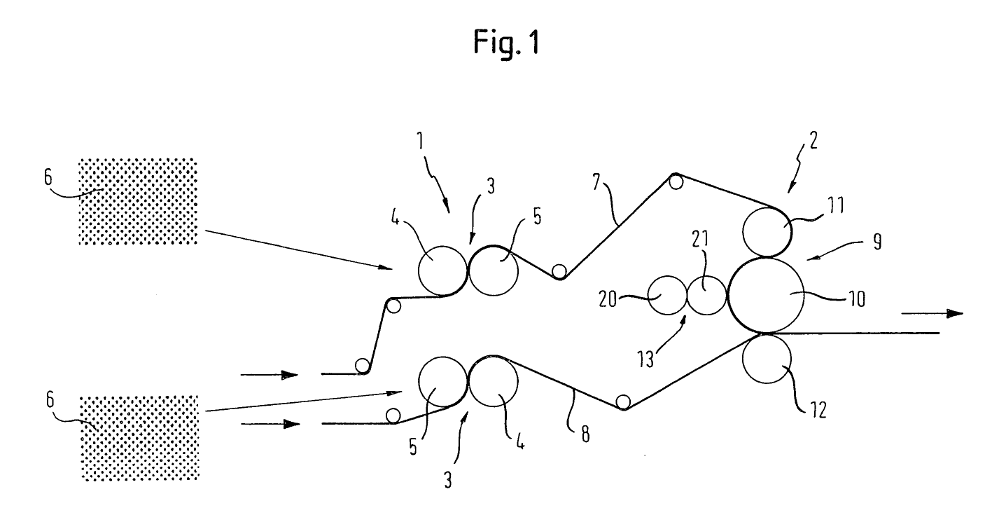

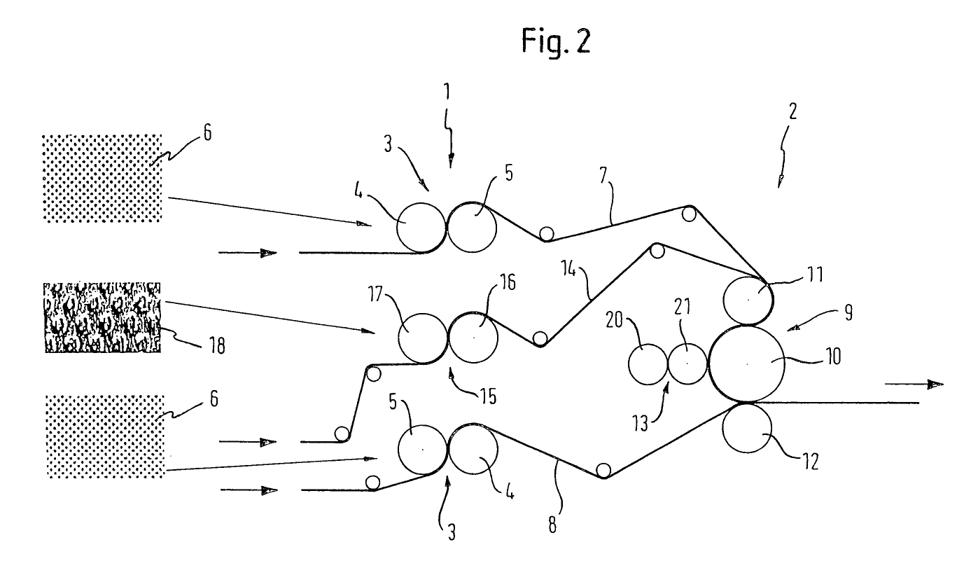

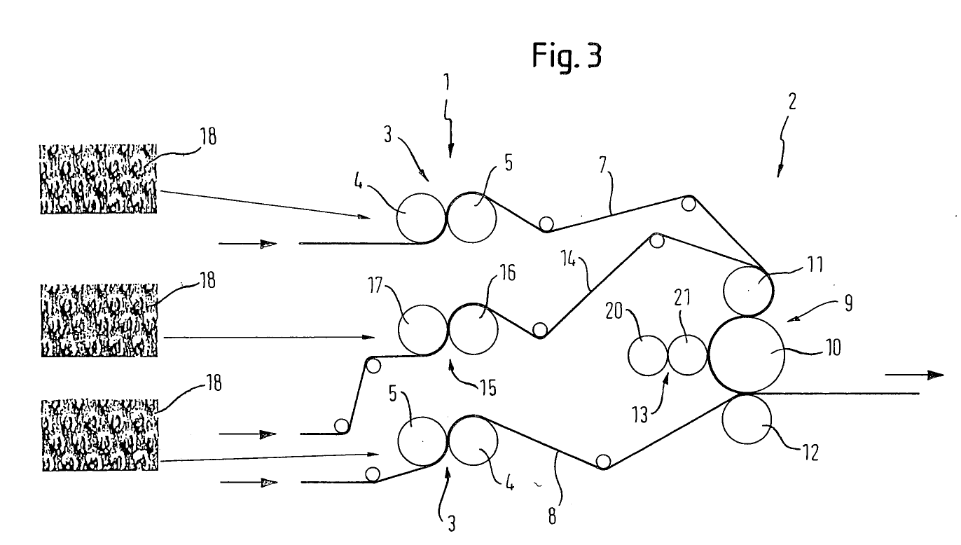

FIG. 3 shows a preferred embodiment of the present invention. The principle arrangement of the apparatus shown in FIG. 3 is similar to the conventional apparatus shown in FIGS. 1 and 2 described above. In order to avoid repetition, here the respective description of same elements is omitted and reference is made to the description above of FIGS. 1 and 2.

The shown embodiment differs from the one shown in FIGS. 1 and 2 in that the decoration embossing roll (10) has an engraving depth of, for example, 2 mm and the decoration backing roll (11) has a hardness of 80 Shore (A). With these modifications, a loss of bulk during the embossing of the design elements, i.e. during decoration embossing can sufficiently be decreased, which also permits the use of a macro pattern (18) for the background embossing (3).

However, it is sufficient to only provide one of the features of the decoration embossing roll having an engraving depth of larger than 1.5 mm or a hardness of greater than 60 Shore (A) of the embossing backing roll to increase bulk. The additional middle ply embossing and the usage of a macro background pattern further amplifies this effect, but may be also omitted. The results of the respective features will become more apparent from the following examples:

### EXAMPLE 1

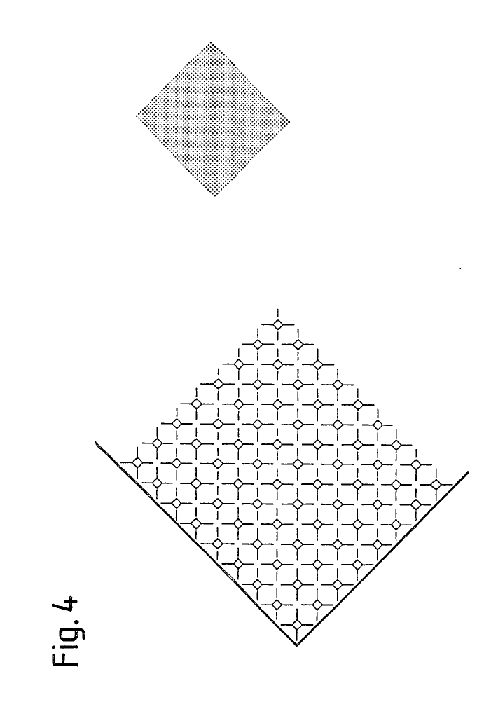

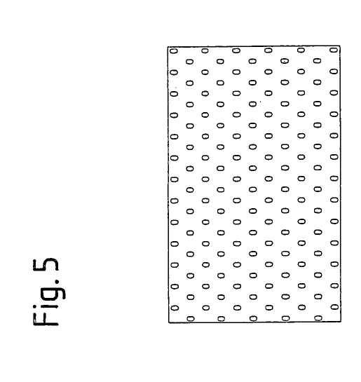

A three-ply tissue product in the form of a continuous web as a roll with a sheet count of 150 has been manufactured having a micro-embossing as the background pattern, as shown in FIG. 4, a macro pattern for the middle-embossed ply and a dolphin design, as shown in FIG. 5, as the decoration embossing.

A first three-ply tissue product is produced on an apparatus according to FIG. 2 of the present application, namely with a state of the art apparatus, and a second roll is produced by an apparatus according to the embodiment of the present invention, wherein, compared to the standard apparatus, only the engraving depth of the decoration embossing roll has been increased from 1.4 mm for the standard decoration embossing roll to 2 mm for the decoration embossing roll of the present invention. The remaining machine parameters, are constant (standard nips, web tension 30 N/m). Subsequently, the two tissue products in the form of a roll are compared regarding their roll diameters.

The diameter of the standard roll (first roll) is 119 mm. In contrast, the diameter of the roll (second roll) produced on an apparatus having a decoration embossing roll with an engraving depth of 2 mm according to the present invention, is 128 mm. As is apparent, the bulk of the tissue product obtained by an apparatus according to the present invention has been significantly increased.

### EXAMPLE 2

In the second example, a similar three-ply tissue product as in Example 1 has been manufactured. However, in this example, for both products, the decoration embossing roll has an engraving depth of 1.4 mm. In contrast to Example 1, the hardness of the decoration backing roll of the standard apparatus on which a first standard roll is produced is 50 Shore (A), whereas the hardness of the decoration backing roll of the apparatus according to the embodiment of the present invention on which a second roll is produced is 80 Shore (A). Again, all remaining machine parameters are constant.

The diameter of the three-ply tissue product roll (first roll) produced by the standard apparatus is 119 mm, whereas the three-plied tissue product roll (second roll) produced by the apparatus according to the present invention is 127 mm. Thus, the tissue product roll is again significantly increased in its bulk in accordance with the present invention.

### EXAMPLE 3

In the third example, also a similar three-ply tissue product has been produced, but in this case the features mentioned in Examples 1 and 2 of the present invention have been combined. Hence, one three-ply tissue product roll (first roll) is produced by a standard apparatus, the decoration embossing roll having an engraving depth of 1.4 mm and a decoration backing roll having a hardness of 50 Shore (A). Further, a second three-ply tissue product roll (second roll) is produced on an apparatus according to a preferred embodiment of the present invention in which the engraving depth of the decoration embossing roll is 2 mm and the hardness of the decoration backing roll is 80 Shore (A). All remaining machine parameters are again constant. The diameter measured for the standard three-ply tissue product roll (first roll) is again 119 mm, whereas the diameter of the three-ply tissue paper roll produced on an apparatus according to the preferred embodiment of the present invention is 132 mm. As it will be apparent, the bulk in this case is remarkably increased in accordance with the present invention compared to the standard apparatus.

### EXAMPLE 4

In the fourth example, a two-ply tissue product with a sheet count of 150 is produced having a dolphin design, as shown in FIG. 5, as the decoration embossing pattern. A first two-ply tissue paper roll is produced on an apparatus as shown in FIG. 1 of the present application, having a decoration embossing roll with an engraving depth of 1.4 mm, a decoration backing roll with a hardness of 50 Shore (A) and on which a standard micro background pattern of 60 dots/cm² is applied in advance of the decoration embossing. In contrast, a second two-plied tissue product roll is produced according to a preferred embodiment of the present application, in which the decoration embossing roll has an engraving depth of 2 mm and the decoration backing roll has a hardness of 80 Shore (A). Further, a macro pattern is applied as background pattern, which is enabled due to the enlarged engraving depth of the decoration embossing roll and the increased hardness of the decoration backing roll. Again, comparing the roll diameters, it becomes apparent that, in the standard apparatus, a roll (first roll) is produced having a diameter of 123 mm, whereas in the apparatus according to the preferred embodiment of the present invention, a roll (second roll) diameter of 169 mm can be achieved. Also in this case, a remarkable increase in bulk has been obtained in accordance with the present invention.

FIG. 4 shows an example of a standard micro pattern as background embossing. Various forms of the knobs are possible, such as, e.g., a frustum (circular or oval) or a frustum of pyramid (square or rectangular base).

FIG. 5, on the other hand, shows an example of a macro pattern, the knobs of which may have the same form as the micro-embossing as aforementioned.

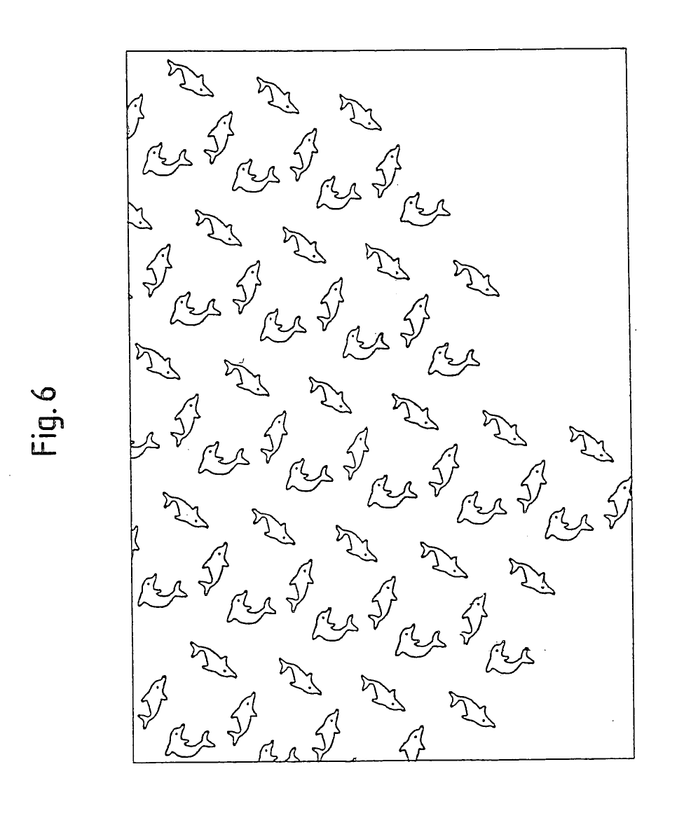

FIG. 6 shows an example of a design pattern in the form of dolphins as decoration embossing.

As will be apparent, the present invention is not limited by the preferred embodiments described with reference to the accompanying drawings, but can be modified in various ways without departing from the scope of the invention defined in the appended claims.

1. Apparatus for embossing a multi-ply paper product, comprising at least one background embossing unit for embossing at least one ply of the multi-ply paper product and at least one decoration embossing unit for embossing the at least one ply downstream of the background embossing unit, as seen in the direction of processing, the decoration embossing unit having a decoration embossing roll and a decoration backing roll, wherein the decoration embossing roll of the decoration embossing unit has an engraving depth larger than 1.5 mm.

2. Apparatus according to claim 1, wherein the decoration embossing roll has an engraving depth less than or equal to 3.5 mm.

3. Apparatus according to claim 1, wherein the engraving depth of the decoration embossing roll is 2.0 mm.

4. Apparatus according to claim 1, wherein the decoration backing roll has a hardness larger than 60 Shore (A).

5. Apparatus according to claim 4, wherein the hardness of the decoration backing roll is less than or equal to 95 Shore (A).

6. Apparatus according to claim 4, wherein the hardness of the decoration backing roll is 80 Shore (A).

7. Apparatus according to claim 1, wherein the decoration backing roll is made of rubber, paper, polyamide or textile.

8. Apparatus according to claim 1, wherein the background embossing unit is adapted to apply a macro embossing to the one ply of the paper product.

9. Apparatus according to claim 1, wherein the background embossing unit is adapted to apply a micro embossing to the one ply of the paper product.

10. Apparatus according to claim 1, wherein the background embossing unit is adapted to apply a micro embossing and a macro embossing to the one ply of the paper product.

11. Apparatus according to claim 9, wherein the micro embossing pattern to be substantially uniformly applied to the one ply of the paper product comprises approximately 30 to 100 dots/cm².

12. Apparatus according to claim 8, wherein the macro embossing pattern to be substantially uniformly applied to the one ply of the paper product comprises less than approximately 25 dots/cm².

13. Apparatus according to claim 1, wherein the paper product comprises at least three plies and the background embossing unit further comprises a middle embossing/backing roll combination for applying a macro embossing to a middle ply of the multi-ply paper product.

14. Apparatus according to claim 1, wherein the apparatus further comprises a calender unit upstream or downstream of the embossing units, as seen in the direction of processing.

15. Apparatus according to claim 1, further comprising an adhering station for applying an adhesive to the at least one ply.

16. Apparatus according to claim 9, wherein the micro embossing pattern to be substantially uniformly applied to the one ply of the paper product comprises approximately 40 dots/cm².

17. Apparatus according to claim 8, wherein the macro embossing pattern to be substantially uniformly applied to the one ply of the paper product comprises between 5 to 16 dots/cm².

18. Multi-ply paper product manufactured by the apparatus according to claim 1.

19. Method for embossing a multi-ply paper product, comprising the steps of:
embossing at least one ply of the multi-ply paper product with a background embossing unit,
embossing the at least one ply downstream of the step of the background embossing with a decoration embossing unit, having a decoration embossing roll and a decoration backing roll, wherein the decoration embossing roll of the decoration embossing unit has an engraving depth larger than 1.5 mm.

20. Method according to claim 19, wherein the decoration backing roll has a hardness larger than 60 Shore (A) and less than or equal to 95 Shore.

21. Method according to claim 19, wherein in the step of the background embossing a macro embossing is applied to the one ply of the paper product.

22. Method according to claim 19, wherein in the step of the background embossing a micro embossing is applied to the one ply of the paper product.

23. Method according to claim 19, wherein in the step of the background embossing a micro embossing and a macro embossing are applied to the one ply of the paper product.

24. Method according to claim 19, further comprising a step of applying an adhesive to the at least one ply and marrying the at least one ply with at least one other ply of the paper product.

25. Method according to claim 19, wherein the decoration backing roll has a hardness of 80 Shore (A).
